(19) United States
(12) Patent Application Publication
(10) Pub. No.: US 2003/0113634 A1
(43) Pub. Date: Jun. 19, 2003

(54) Organic electrolytic solutions containing ethylenically unsaturated compounds, and polymer electrolytes and lithium batteries using the same

(75) Inventors: Won-Seog Oh, Seoul (KR); Sang-Won Lee, Gunpo-City (KR); Kwang Sup Kim, Cheonan-City (KR); Sang-Hoon Choy, Daejeon Metropolitan City (KR)

Correspondence Address: STAAS & HALSEY LLP, 700 11TH STREET, NW, SUITE 500, WASHINGTON, DC, 20001, US

(73) Assignee: SAMSUNG SDI CO., LTD., Suwon-City (KR)

(21) Appl. No.: 10/232,315

(22) Filed: Sep. 3, 2002

(30) Foreign Application Priority Data
Sep. 13, 2001 (KR) 2001-56438

(51) Int. Cl. H01M 10/40

(52) U.S. Cl. 429/326; 429/330; 429/339; 429/340; 429/307

(57) ABSTRACT

An organic electrolytic solution includes ethylenically unsaturated compounds which suppress swelling of a battery due to the gas produced when the battery is stored at high temperature or when charging/discharging cycles are repeatedly performed, and reduces internal resistance of the battery. Polymer electrolytes and lithium batteries are manufactured using the organic electrolytic solutions. The ethylenically unsaturated compounds are vinylene carbonates, vinyl sulfones, acrylonitriles or derivatives thereof.

### CROSS-REFERENCE TO RELATED APPLICATION

This application claims the benefit of Korean Application No. 2001-56438, filed Sep. 13, 2001, in the Korean Intellectual Property Office, the disclosure of which is incorporated herein by reference.

### BACKGROUND OF THE INVENTION

1. Field of the Invention

The present invention relates to organic electrolytes, and polymer electrolytes and lithium batteries manufactured using the organic electrolytic solutions, and more particularly, to organic electrolytic solutions containing ethylenically unsaturated compounds which suppress a swelling of a battery due to gas produced when the battery is stored at a high temperature or when charging/discharging cycles are repeatedly performed, and reduce internal resistance of the battery, and polymer electrolytes and lithium batteries manufactured using the organic electrolytic solutions.

2. Description of the Related Art

In general, a nonaqueous lithium battery includes a lithium anode, an electrolyte made of a lithium salt dissolved in at least one organic solvent, and a cathode of an electrochemically active material, which is typically a transition metal chalcogenide. During discharging, lithium ions are transferred from the anode to the cathode through the electrolyte. During charging, the flow of the lithium ions is reversed. Thus, the lithium ions are transferred from the cathode active material through the electrolyte and back to the lithium anode to be plated thereon. Various nonaqueous lithium batteries are disclosed in U.S. Pat. Nos. 4,472,487, 4,668,595, 5,028,500, 5,441,830, 5,460,904 and 5,540,741.

In order to overcome the formation of dendrite and the growth of a lithium sponge, it has been proposed to replace the lithium metal anode with a carbon anode such as cokes or graphites, in which intercalation of lithium ions occurs to form LiₓC₆. Such a battery operates similar to a battery with a lithium metal anode. Specifically, the lithium ions are transported from the carbon anode to the cathode in which lithium ions released from the carbon anode are absorbed through the electrolyte. During recharging, lithium ions are transferred back to the anode and intercalated into the carbon. Since no metallic lithium exists in the battery, the anode never melts down even under severe conditions. Also, since the lithium ions are recombined into the anode by intercalation rather than by plating, the growth of the dendrite and the lithium sponge does not occur.

Electrolytes for lithium batteries are largely divided into three types: electrolytic solutions, gel-type polymer electrolytes, and solid polymer electrolytes, and have been separately studied. In recent years, much attention has been paid to polymer electrolytes prepared by compounding polyethylene oxide-based polymers and lithium salts. For example, U.S. Pat. No. 4,303,748 discloses a compound of a polyethylene oxide and a lithium salt which exhibits ionic conductivity, and a battery using the compound. It is known that the polyethylene oxide-based polymer produces a complex structure with the lithium salt and exhibits ionic conductivity by heat movement of polymer chains. Thus, voids used to allow an electrolytic solution to pass through (such as voids of a separator), are not essentially required for the battery. However, the ionic conductivity exhibited by the polymer electrolyte is not yet satisfactory.

It has recently been reported that a gel-type polymer electrolyte prepared by adding a solvent and an organic electrolytic solution to a thermoplastic polymer, such as polyacrylonitrile or polyfluorovinylidene, improved ionic conductivity. An example is described in J. Appl. Electrochem., No. 5, pp. 63-69 (1995). Another example is disclosed in U.S. Pat. No. 4,792,504, which discloses a polymeric electrolyte having improved ionic conductivity. The polymeric electrolyte has an electrolytic solution consisting of a lithium salt and an aprotic solvent impregnated into a network of crosslinked polyethylene oxide.

Since polymeric electrolytes have organic electrolytic solutions each consisting of a nonaqueous organic solvent and a lithium salt similar to that used in polymer ion batteries, a consideration must be taken into the compatibility between the organic electrolytic solution, the cathode and the anode. In particular, when using a crystalline carbon anode, some irreversibility in capacity occurs by a side reaction of the anode and the organic electrolytic solution occurring at the surface of the anode. The irreversibility is due to an electrochemical reduction of the organic solvent intercalated into planes of the carbon material.

U.S. Pat. No. 5,352,548 discloses an organic solvent containing 20 to 80 wt % vinylene carbonate to improve low-temperature discharge characteristics of a battery. However, since vinylene carbonate is expensive, the disclosed organic solvent is economically disadvantageous.

Also, a battery case may swell due to carbon dioxide gas generated by the decomposition of the organic solvent, such as, propylene carbonate, while reacting with the anode.

### SUMMARY OF THE INVENTION

To solve the above and other problems, it is an object of the present invention to provide an organic electrolytic solution which prevents swelling of a lithium battery and reduces internal resistance within the lithium battery.

It is another object of the present invention to provide a polymer electrolyte having either the organic electrolytic solution impregnated into a polymeric matrix, or a gel-type polymer electrolyte prepared by polymerizing a mixture of a thermopolymerizable polymer or its monomer and the organic electrolytic solution.

It is a further object of the present invention to provide a lithium battery using one of the polymer electrolyte and the gel-type polymer electrolyte.

Additional objects and advantages of the invention will be set forth in part in the description which follows and, in part, will be obvious from the description, or may be learned by practice of the invention.

To accomplish the above and other objects of the present invention, there is provided an organic electrolytic solution according to an embodiment of the invention including a lithium salt, a nonaqueous organic solvent, and an ethylenically unsaturated compound, wherein the ethylenically unsaturated compound has a boiling point at or between 50 and 170° C. and a content thereof is at or between 0.01 and 6% by weight, based on the total weight of the nonaqueous organic solvent.

According to another embodiment of the present invention, a polymer electrolyte for a lithium battery includes a polymer matrix having voids and the organic electrolytic solution including a lithium salt and a nonaqueous organic solvent impregnated into the voids.

According to yet another embodiment of the present invention, a gel-type polymer electrolyte for a lithium battery includes an organic electrolytic solution including a lithium salt and a nonaqueous organic solvent, and a polymerizable polymer or its monomer.

According to a further embodiment of the invention, a lithium battery is prepared by inserting a polymer electrolyte between a cathode and an anode, which are capable of absorbing/releasing lithium ions, and laminating the resultant structure, wherein the polymer electrolyte comprises a polymer matrix having voids into which the organic electrolytic solution is impregnated.

According to a still further embodiment of the invention, a lithium battery is prepared by inserting a separator between a cathode and an anode to prepare a sheet which is capable of absorbing/releasing lithium ions, and winding the sheet to form an electrode assembly and putting the electrode assembly into a pouch, wherein the separator is a gel-type polymer electrolyte prepared by adding a mixed solution of the organic electrolytic solution and a thermopolymerizable polymer or its monomer and thermopolymerizing the mixed solution.

According to a yet still further embodiment of the present invention, a lithium battery is prepared by inserting a gel-type polymer electrolyte formed by coating a surface of a cathode that is capable of absorbing/releasing lithium ions and/or an anode that is capable of absorbing/releasing lithium ions, the coating comprising a mixed solution of the organic electrolytic solution and a thermopolymerizable polymer, thermopolymerizing the coated structure, and winding the resultant structure of the cathode and anode such that the coating is between the cathode and anode.

### BRIEF DESCRIPTION OF THE DRAWING

These and other objects and advantages of the invention will become more apparent and more readily appreciated from the following description of the embodiments, taken in conjunction with the accompanying drawing of which:

FIG. 1 shows a lithium battery according to an embodiment of the present invention.

### DETAILED DESCRIPTION OF THE EMBODIMENTS

Reference will now be made in detail to the present embodiments of the present invention, examples of which are illustrated in the accompanying drawing and Specific Examples, wherein like reference numerals refer to the like elements throughout. The embodiments are described below in order to explain the present invention by referring to the figure and Specific Examples.

An organic electrolytic solution according to an embodiment of the invention includes a lithium salt, a nonaqueous organic solvent, and an ethylenically unsaturated compound. The ethylenically unsaturated compound has a boiling point at or between 50 and 170° C. A content of the ethylenically unsaturated compound is at or between 0.01 and 6% by weight, based on the total weight of the nonaqueous organic solvent.

Organic electrolytic solutions that are generally used are ionic conductors having lithium salts dissolved in an organic solvent. Organic electrolytic solutions have good lithium ionic conductivity and high chemical and electrochemical stability with respect to electrodes including cathodes and anodes. Also, the organic electrolytic solutions are usable over a broad range of the working temperatures, and are generally manufacturable at low cost. Therefore, organic solvents having high ionic conductivities, high dielectric constants, and low viscosities are suitably used.

While one may be developed, there is presently no single-component organic solvent that can meet the above-described requirements. Thus, an organic solvent in an organic electrolytic solution generally includes a two-component system including a high dielectric constant solvent and a low-viscosity solvent, such as that disclosed in U.S. Pat. Nos. 5,437,945 and 5,639,575, or a three-component system further including a low freezing point organic solvent, such as that disclosed in U.S. Pat. Nos. 5,475,862 and 5,639,575, the discloses of which are incorporated herein by reference. The present invention further comprises ethylenically unsaturated compounds in the two-component organic solvent or the three-component organic solvent. Thus, the organic electrolytic solution containing the ethylenically unsaturated compound is reduced at a potential 1 V higher than when the solution contains lithium, to form a coating on the surface of the anode. In other words, during initial charging after the manufacture of a battery, a physical layer is formed on the surface of the anode that is not yet subjected to intercalation of lithium ions. The layer is of an ethylenically unsaturated compound, which prevents the battery from swelling due to an anode surface reaction by a nonaqueous organic solvent. The layer also overcomes problems due to increased internal resistance and reduced discharge capacity.

The content of the ethylenically unsaturated compound is at or between 0.01 and 6% by weight, and preferably, 1.5 and 2.5% by weight, based on the total weight of the nonaqueous organic solvent according to embodiments of the invention. If the content of the ethylenically unsaturated compound is less than 0.01% by weight, the formed coating cannot prevent a reaction of nonaqueous solvent from occurring on the surface of the anode. If the content of the ethylenically unsaturated compound is greater than 6% by weight, the low temperature performance of the battery may deteriorate due to a high melting point of the ethylenically unsaturated compound. Also, since the amount of another nonaqueous solvent is relatively lowered, the battery performance may substantially deteriorate. In other words, in an embodiment of the present invention, the amount of the ethylenically unsaturated compound used is similar to the amounts of additives used. However, it is understood that the amount need not correspond to the amount of additives used in all aspects of the invention.

The ethylenically unsaturated compound is at least one selected from the group consisting of vinylene carbonate, vinyl sulfone, acrylonitrile, and derivatives thereof according to an embodiment of the invention.

In the nonaqueous organic solvent of the organic electrolytic solution according to an embodiment of the present invention, the ethylenically unsaturated compound and the another nonaqueous organic solvents other than vinylene carbonate or its derivatives include all conventional mixed nonaqueous organic solvents. Examples of the another nonaqueous organic solvents include ring-type carbonates, such as ethylene carbonate or propylene carbonate, linear carbonates such as dimethyl carbonate, diethyl carbonate or dimethylethyl carbonate.

In addition to the ethylenically unsaturated compound, the organic electrolytic solution includes fluorobenzene according to an embodiment of the invention. The content of fluorobenzene is at or between 5 and 15% by weight, based on the total weight of the nonaqueous organic solvent.

The organic electrolytic solution according to an embodiment of the present invention is used in a lithium ion battery such as a lithium battery using the organic electrolytic solution as an electrolyte. However, the organic electrolytic solution according to another embodiment of the present invention is applied to a polymer electrolyte having the organic electrolytic solution impregnated into a polymeric matrix, or to a gel-type polymer electrolyte prepared by thermally polymerizing a mixed solution of a thermopolymerizable polymer or its monomer and an organic electrolytic solution.

According to a further embodiment of the present invention, a polymer electrolyte is obtained using the organic electrolytic solution. Specifically, a polymer electrolyte for a lithium battery is used. The polymer electrolyte includes a polymer matrix having voids. The organic electrolytic solution, which consists of the lithium salt and the nonaqueous organic solvent, is impregnated into the voids.

According to another aspect of the present invention, a gel-type polymer electrolyte for the lithium battery includes the organic electrolytic solution, which includes the lithium salt and the nonaqueous organic solvent, and a polymerizable polymer or its monomer.

In the organic electrolytic solution, the lithium salt is not particularly restricted and any lithium salt known or later developed in the art can be used in an amount within a generally accepted range. Usable lithium salts include, but are not limited to, LiPF₆, LiBF₄, LiAsF₆, LiClO₄, CF₃SO₃Li, LiC(CF₃SO₂)₃, LiN(C₂F₅SO₂)₂, LiN(CF₃SO₂)₂, LiCoO₂, LiNiO₂, LiMnO₂, LiMn₂O₄, and LiNi₁₋ₓCoₓO₂.

According to embodiments of the present invention, a lithium battery includes the organic electrolytic solution and one of the polymer electrolyte and the gel-type polymer electrolyte. According to one embodiment, the lithium battery is prepared by inserting the polymer electrolyte between a cathode and an anode capable of absorbing/releasing lithium ions, and laminating the resultant structure. The polymer electrolyte comprises a polymer matrix having voids, into which the organic electrolytic solution is impregnated.

According to another embodiment, the lithium battery is prepared by inserting a separator between the cathode and the anode, and winding the combination to form an electrode assembly. The electrode assembly is put into a pouch. The separator is a gel-type polymer electrolyte prepared by adding a mixed solution of the organic electrolytic solution and a thermopolymerizable polymer or its monomer, and thermopolymerizing the mixture.

According to another embodiment, a lithium battery is prepared by inserting a gel-type polymer electrolyte formed by coating a surface of the cathode and/or a surface of the anode. The coating comprises a mixed solution of the organic electrolytic solution and a thermopolymerizable polymer. The coated structure is then thermopolymerized. The combined anode and cathode are wound such that the coating is between the anode and cathode.

As described above, any cathode, anode, polymeric matrix having voids and/or separator can be used and/or prepared by known methods in the art or method later developed. The lithium batteries according to the present invention include, but are not specifically limited, lithium primary batteries, and lithium secondary batteries such as lithium ion polymer batteries and lithium ion batteries.

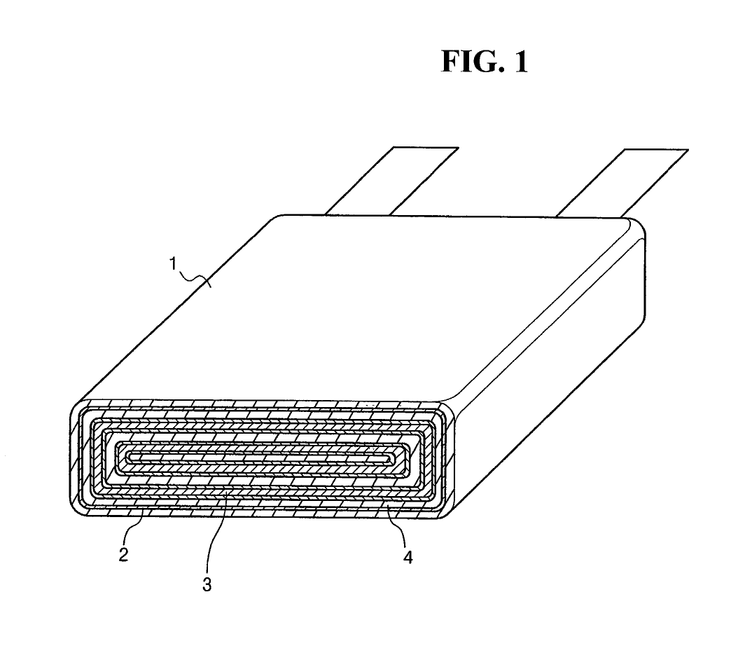

As shown in FIG. 1, a lithium-sulfur battery according to an embodiment of the present invention includes a case 1 containing a positive electrode (i.e., a cathode) 3, a negative electrode (i.e., an anode) 4, and a separator 2 interposed between the positive electrode 3 and the negative electrode 4. The organic electrolytic solution is disposed between the positive and negative electrodes 3, 4.

The present invention will now be described in detail with reference to Examples and Comparative Examples. However, it is understood that the invention is not limited thereto.

LiPF6 (cell reagent grade, HASHIMOTO CO., Japan) was used in the Examples and the Comparative Examples without refining. The solvent used to prepare an organic electrolytic solution was a cell reagent grade product manufactured by MERCK CO. (Germany). All experiments were performed under an at least 99.9999% argon (Ar) gas atmosphere.

### EXAMPLE 1

First, a reagent bottle containing a solid ethylene carbonate (EC) was put in an electrical mantle and slowly heated to 70 to 80° C. to be liquefied. Then, LiPF₆ was added to prepare a 1 M LiPF₆ solution in a plastic bottle in which the electrolyte is to be stored. Ethylmethyl carbonate (EMC), dimethyl carbonate (DMC) and fluorobenzene (FB) were added to the plastic bottle, and then vigorously shaken to dissolve the Li metal salt. Here, the EC, the EMC, the DMC and the FB were added at a ratio of 30:30:30:10 based on the weight. Then, vinylene carbonate (VC) was added to be 2% by weight based on the total weight of a desired product, yielding an organic electrolytic solution according to an embodiment of the present invention.

### EXAMPLE 2

An organic electrolytic solution was prepared by the same method as in Example 1 except that the mixture ratio of the EC, the EMC, the DMC and the FB was adjusted to 30:35:25:10 based on the weight.

### EXAMPLE 3

An organic electrolyte was prepared by the same method as in Example 1 except that propylene carbonate (PC) was used instead of the FB.

### EXAMPLE 4

An organic electrolytic solution was prepared by the same method as in Example 3 except that the mixture ratio of the EC, the EMC, the DMC and the PC was adjusted to 30:50:10:10 based on the weight.

### EXAMPLES 5-8

Organic electrolytic solutions were prepared by the same methods as in Examples 1-4, respectively, except that vinyl sulfone was used instead of the VC.

### EXAMPLES 9-12

Organic electrolytic solutions were prepared by the same methods as in Examples 1-4, respectively, except that acrylonitrile was used instead of the VC.

### Comparative Example 1-4

Organic electrolytes were prepared by the same methods as in Examples 1-4, respectively, except that the VC was not added to the respective mixtures of Examples 1-4.

### Comparative Example 5-9

Organic electrolytes were prepared by the same method as in Example 1 except that 2% by weight of propane sultone, 1.0% by weight of propane sultone, 1.0% by weight of vinylene sulfonate, 0.5% by weight of fluoromethylether and 1.0% by weight of fluoromethylether were added, respectively, instead of the vinylene carbonate (VC) of Example 1.

### Experimental Example

Lithium batteries containing gel-type polymer electrolytes were manufactured using the organic electrolytic solutions of Examples 1-4 and Comparative Examples 1-9, and internal resistance and swelling when each battery was stored at high temperature of approximately 85° C., were measured.

A copolymer (VdF-HFP) of vinylidenefluoride and hexafluoropropylene as a binder was added to a mixed organic solvent of cyclo-hexanone and acetone using a ball-mill to be dissolved. LiCoO₂ as a cathode active material and carbon black as a conductive agent were added to the resultant mixture and mixed to form a cathode active material composition. The cathode active material composition was coated on an aluminum (Al) foil having a thickness of 147 μm and a width of 4.9 cm using a doctor blade having a gap of 320 μm, and dried, resulting in a cathode sheet. The Al foil was coated with a pre-treatment composition by a spray coating process, for pre-treatment. The pre-treatment composition was prepared by adding a copolymer (VdF/HFP) and carbon black to a mixed organic solvent of cyclo-hexanone and acetone and mixing.

An anode sheet was formed by the following method. A copolymer (VdF-HFP) of vinylidenefluoride and hexafluoropropylene as a binder was added to a mixed organic solvent of N-methylpyrrolidone (NMP) and acetone using a ball-mill to be dissolved. Mezocarbon fiber (MCF) as an anode active material was added to the resultant mixture and mixed to form an anode active material composition. The anode active material composition was coated on a copper (Cu) foil having a thickness of 178 μm and a width of 5.1 cm using a doctor blade having a gap of 420 μm, and dried, resulting in an anode sheet. The Cu foil was coated with a pre-treatment composition by a spray coating process, for pre-treatment. The pre-treatment composition was prepared by adding a copolymer (VdF/HFP) and carbon black to a mixed organic solvent of cyclo-hexanone and acetone and mixing.

To the organic electrolytic solutions prepared in Examples 1-4 and Comparative Examples 1-9 were added a copolymer (VdF-HFP) and silica as an organic filler, followed by elevating the temperature, thereby preparing gel-type polymer electrolytes. The gel-type polymer electrolytes were coated between the cathode sheet and the anode sheet and wound by a jelly-roll method to fabricate electrode assemblies. The electrode assemblies were then put into pouches to form the lithium batteries.

Internal resistance, swelling and 2C capacity of the obtained lithium batteries were measured, and the results are shown in Tables 1, 2 and 3.

TABLE 1

| | | |
|---|---|---|
| Before high temperature storage | After high temperature | Variation |

| | | Internal | | | | Internal | | | | Internal | | |
|---|---|---|---|---|---|---|---|---|---|---|---|---|
| | Temp. | resistance | OCV | Thickness | Weight | resistance | OCV | Thickness | Weight | resistance | OCV | Swelling |
| | (° C.) | (mohm) | (V) | (mm) | (g) | (mohm) | (V) | (mm) | (g) | (mohm) | (V) | (%) |
| Comparative | 75.0 | 142.0 | 4.2 | 3.9 | 12.5 | 230.0 | 4.2 | 4.1 | 12.5 | 88.0 | 0.0 | 6.7 |
| Example 1 | | | | | | | | | | | | |
| | 57.0 | 92.0 | 4.2 | 3.8 | 12.4 | 151.0 | 4.2 | 4.1 | 12.4 | 59.0 | 0.0 | 6.8 |
| Average | 66.0 | 117.0 | 4.2 | 3.9 | 12.4 | 190.5 | 4.2 | 4.1 | 12.4 | 73.5 | 0.0 | 6.8 |
| Example 1 | 55.0 | 92.0 | 4.2 | 3.7 | 12.5 | 125.0 | 4.2 | 4.1 | 12.5 | 33.0 | 0.0 | 8.3 |
| | 49.0 | 93.0 | 4.2 | 3.9 | 12.5 | 131.0 | 4.2 | 4.1 | 12.5 | 38.0 | 0.0 | 5.2 |
| | 61.0 | 122.0 | 4.2 | 3.9 | 12.4 | 175.0 | 4.2 | 4.1 | 12.4 | 53.0 | 0.0 | 5.2 |
| | 56.0 | 108.0 | 4.2 | 3.8 | 12.5 | 154.0 | 4.2 | 4.1 | 12.5 | 46.0 | 0.0 | 7.9 |
| Average | 55.3 | 103.8 | 4.2 | 3.8 | 12.5 | 146.3 | 4.2 | 4.1 | 12.5 | 42.5 | 0.0 | 6.6 |
| Comparative | 59.0 | 83.0 | 4.2 | 3.8 | 12.4 | 125.0 | 4.2 | 4.2 | 12.4 | 42.0 | 0.0 | 8.9 |
| Example 2 | | | | | | | | | | | | |
| | 58.0 | 82.0 | 4.2 | 3.9 | 12.5 | 124.0 | 4.2 | 4.4 | 12.5 | 42.0 | 0.0 | 14.3 |
| | 61.0 | 83.0 | 4.2 | 3.9 | 12.5 | 126.0 | 4.2 | 4.1 | 12.5 | 43.0 | 0.0 | 6.2 |
| | 58.0 | 78.0 | 4.2 | 3.9 | 12.5 | 116.0 | 4.2 | 4.2 | 12.5 | 38.0 | 0.0 | 8.8 |
| Average | 59.0 | 81.5 | 4.2 | 3.8 | 12.5 | 122.8 | 4.2 | 4.2 | 12.5 | 41.3 | 0.0 | 9.6 |
| Example 2 | 51.0 | 83.0 | 4.2 | 3.8 | 12.3 | 114.0 | 4.2 | 4.0 | 12.3 | 31.0 | 0.0 | 6.9 |
| | 64.0 | 116.0 | 4.2 | 3.8 | 12.5 | 167.0 | 4.2 | 4.1 | 12.5 | 51.0 | 0.0 | 7.3 |
| | 54.0 | 86.0 | 4.2 | 3.8 | 12.5 | 115.0 | 4.2 | 4.1 | 12.5 | 29.0 | 0.0 | 8.4 |
| | 52.0 | 83.0 | 4.2 | 3.8 | 12.6 | 110.0 | 4.1 | 4.1 | 12.6 | 27.0 | 0.0 | 6.3 |
| Average | 55.3 | 92.0 | 4.2 | 3.8 | 12.5 | 126.5 | 4.2 | 4.1 | 12.5 | 34.5 | 0.0 | 7.2 |

TABLE 2

| | | |
|---|---|---|
| Before high temperature storage | After high temperature storage | Variation |

| | | Internal | | | | Internal | | | | Internal | | |
|---|---|---|---|---|---|---|---|---|---|---|---|---|
| | Temp. | resistance | OCV | Thickness | Weight | resistance | OCV | Thickness | Weight | resistance | OCV | Swelling |
| | (° C.) | (mohm) | (V) | (mm) | (g) | (mohm) | (V) | (mm) | (g) | (mohm) | (V) | (%) |
| Comparative | 61.0 | 88.0 | 4.2 | 3.8 | 12.5 | 131.0 | 4.2 | 4.3 | 12.5 | 43.0 | 0.0 | 12.4 |
| Example 3 | | | | | | | | | | | | |
| | 58.0 | 90.0 | 4.2 | 3.8 | 12.4 | 141.0 | 4.2 | 4.2 | 12.4 | 51.0 | 0.0 | 8.9 |
| | 62.0 | 95.0 | 4.2 | 3.8 | 12.4 | 135.0 | 4.2 | 4.1 | 12.4 | 40.0 | 0.0 | 9.5 |
| | 59.0 | 87.0 | 4.2 | 3.8 | 12.4 | 133.0 | 4.2 | 4.2 | 12.4 | 46.0 | 0.0 | 11.4 |
| Average | 60.0 | 90.0 | 4.2 | 3.8 | 12.4 | 135.0 | 4.2 | 4.2 | 12.4 | 45.0 | 0.0 | 10.6 |
| Example 3 | 52.0 | 83.0 | 4.2 | 3.8 | 12.5 | 109.0 | 4.2 | 4.1 | 12.5 | 26.0 | 0.0 | 6.6 |
| | 53.0 | 84.0 | 4.2 | 3.8 | 12.5 | 115.0 | 4.2 | 4.1 | 12.5 | 31.0 | 0.0 | 7.9 |
| | 53.0 | 87.0 | 4.2 | 3.9 | 12.6 | 118.0 | 4.2 | 4.1 | 12.6 | 31.0 | 0.0 | 5.1 |
| Average | 52.7 | 84.7 | 4.2 | 3.8 | 12.5 | 114.0 | 4.2 | 4.1 | 12.5 | 29.3 | 0.0 | 6.5 |
| Comparative | 70.0 | 133.0 | 4.2 | 3.8 | 12.5 | 232.0 | 4.2 | 4.5 | 12.5 | 99.0 | 0.0 | 19.8 |
| Example 4 | | | | | | | | | | | | |
| | 67.0 | 113.0 | 4.2 | 3.8 | 12.5 | 192.0 | 4.2 | 4.9 | 12.5 | 79.0 | 0.0 | 30.9 |
| Average | 68.5 | 123.0 | 4.2 | 3.8 | 12.5 | 212.0 | 4.2 | 4.7 | 12.5 | 89.0 | 0.0 | 25.3 |
| Example 4 | 52.0 | 78.0 | 4.2 | 3.8 | 12.5 | 115.0 | 4.2 | 4.0 | 12.5 | 37.0 | 0.0 | 6.7 |
| | 56.0 | 80.0 | 4.2 | 3.8 | 12.6 | 117.0 | 4.2 | 4.0 | 12.6 | 37.0 | 0.0 | 5.0 |
| | 51.0 | 78.0 | 4.2 | 3.8 | 12.6 | 112.0 | 4.2 | 4.0 | 12.6 | 34.0 | 0.1 | 6.1 |
| | 53.0 | 81.0 | 4.2 | 3.8 | 12.6 | 116.0 | 4.2 | 4.1 | 12.6 | 35.0 | 0.0 | 9.0 |
| | 52.0 | 82.0 | 4.2 | 3.8 | 12.5 | 117.0 | 4.2 | 4.0 | 12.5 | 35.0 | 0.0 | 7.4 |
| Average | 52.8 | 79.8 | 4.2 | 3.8 | 12.6 | 115.4 | 4.2 | 4.0 | 12.6 | 35.6 | 0.0 | 6.8 |

TABLE 3

| | | | Internal | |
|---|---|---|---|---|
| | | Formation | resistance | 2C capacity |
| | Kind and content of additive | thickness (mm) | (mohm) | (%) |
| Example 1 | 2.0 wt % of vinylene carbonate | 4 | 120 | 80 |
| Comparative | 2.0 wt % of propane sultone | 6 | 250 | 57 |
| Example 5 | | | | |
| Comparative | 1.0 wt % of propane sultone | 6 | 195 | 66 |
| Example 6 | | | | |
| Comparative | 1.0 wt % of vinylene sulfonate | 6 | 173 | 75 |
| Example 7 | | | | |
| Comparative | 1.0 wt % of fluoromethyether | 6 | 450 | 55 |
| Example 8 | | | | |
| Comparative | 2.0 wt % of fluoromethyether | 6 | 330 | 61 |
| Example 9 | | | | |

As shown in Tables 1 through 3, in both cases where different amounts of vinylene carbonate were added to the same organic electrolytic solution, and cases where different kinds of additives were added, the internal resistance and the swelling of the lithium batteries according to the present invention were reduced.

As described above, according to the present invention, the use of the organic electrolytic solutions in manufacturing polymer electrolytes and lithium batteries can advantageously reduce internal resistance and swelling during high temperature storage.

While this invention has been particularly shown and described with reference to embodiments thereof, it will be understood by those skilled in the art that various changes in form and details may be made therein without departing from the spirit and scope of the invention as defined by the accompanying claims and equivalents thereof.

What is claimed is:

1. An organic electrolytic solution comprising:
a lithium salt;
a nonaqueous organic solvent; and
an ethylenically unsaturated compound,
wherein:
said ethylenically unsaturated compound has a boiling point at or between 50 and 170° C., and
a content thereof is at or between 0.01 and 6% by weight, based on a total weight of said nonaqueous organic solvent.

2. The organic electrolytic solution of claim 1, wherein the content of said ethylenically unsaturated compound is at or between 1.5 and 2.5% by weight, based on the total weight of said nonaqueous organic solvent.

3. The organic electrolytic solution of claim 1, wherein said ethylenically unsaturated compound is at least one selected from the group consisting of vinylene carbonate, vinyl sulfone, acrylonitrile, and derivatives thereof.

4. The organic electrolytic solution of claim 1, wherein said nonaqueous organic solvent is at least one mixture of nonaqueous organic solvents selected from the group consisting of ethylene carbonate, propylene carbonate, dimethyl carbonate, diethyl carbonate and dimethylethyl carbonate.

5. An organic electrolytic solution comprising:
a lithium salt;
a nonaqueous organic solvent;
an ethylenically unsaturated compound; and
fluorobenzene,
wherein:
said ethylenically unsaturated compound has a boiling point at or between 50 and 170° C.,
a content of said ethylenically unsaturated compound is at or between 0.01 and 6% by weight, based on a total weight of said nonaqueous organic solvent, and
a content of said fluorobenzene is at or between 5 and 15% by weight, based on the total weight of said nonaqueous organic solvent.

6. The organic electrolytic solution of claim 5, wherein the content of said ethylenically unsaturated compound is at or between 1.5 and 2.5% by weight, based on the total weight of said nonaqueous organic solvent.

7. The organic electrolytic solution of claim 5, wherein said ethylenically unsaturated compound is at least one selected from the group consisting of vinylene carbonate, vinyl sulfone, acrylonitrile, and derivatives thereof.

8. The organic electrolytic solution of claim 5, wherein said nonaqueous organic solvent is at least one mixture of nonaqueous organic solvents selected from the group consisting of ethylene carbonate, propylene carbonate, dimethyl carbonate, diethyl carbonate and dimethylethyl carbonate.

9. A polymer electrolyte comprising:
a polymeric matrix;
a lithium salt;
a nonaqueous organic solvent; and
an ethylenically unsaturated compound,
wherein:
said ethylenically unsaturated compound has a boiling point at or between 50 and 170° C., and
a content thereof is at or between 0.01 and 6% by weight, based on a total weight of said nonaqueous organic solvent.

10. The polymer electrolyte of claim 9, wherein the content of said ethylenically unsaturated compound is at or between 1.5 to 2.5% by weight, based on the total weight of said nonaqueous organic solvent.

11. The polymer electrolyte of claim 9, wherein said ethylenically unsaturated compound is at least one selected from the group consisting of vinylene carbonate, vinyl sulfone, acrylonitrile, and derivatives thereof.

12. The polymer electrolyte of claim 9, wherein said nonaqueous organic solvent is at least one mixture of nonaqueous organic solvents selected from the group consisting of ethylene carbonate, propylene carbonate, dimethyl carbonate, diethyl carbonate and dimethylethyl carbonate.

13. A polymer electrolyte comprising:
a polymer matrix;
a lithium salt;
a nonaqueous organic solvent;
an ethylenically unsaturated compound; and
fluorobenzene,
wherein:
said ethylenically unsaturated compound has a boiling point at or between 50 and 170° C.,
a content of said ethylenically unsaturated compound is at or between 0.01 and 6% by weight, based on the total weight of said nonaqueous organic solvent, and
a content of said fluorobenzene is at or between 5 and 15% by weight, based on a total weight of said nonaqueous organic solvent.

14. The polymer electrolyte of claim 13, wherein the content of said ethylenically unsaturated compound is at or between 1.5 to 2.5% by weight, based on the total weight of said nonaqueous organic solvent.

15. The polymer electrolyte of claim 13, wherein said ethylenically unsaturated compound is at least one selected from the group consisting of vinylene carbonate, vinyl sulfone, acrylonitrile, and derivatives thereof.

16. The polymer electrolyte of claim 13, wherein said nonaqueous organic solvent is at least one mixture of nonaqueous organic solvents selected from the group consisting of ethylene carbonate, propylene carbonate, dimethyl carbonate, diethyl carbonate and dimethylethyl carbonate.

17. A lithium battery comprising:
a cathode;
an anode; and
a polymer electrolyte interposed between said cathode and said anode, said polymer electrolyte comprising:
a polymer matrix;
a lithium salt;
a nonaqueous organic solvent; and
an ethylenically unsaturated compound,
wherein the ethylenically unsaturated compound has a boiling point at or between 50 and 170° C. and a content thereof is at or between 0.01 and 6% by weight, based on a total weight of the nonaqueous organic solvent.

18. The lithium battery of claim 17, wherein the content of the ethylenically unsaturated compound is at or between 1.5 and 2.5% by weight, based on the total weight of the nonaqueous organic solvent.

19. The lithium battery of claim 17, wherein the ethylenically unsaturated compound is at least one selected from the group consisting of vinylene carbonate, vinyl sulfone, acrylonitrile, and derivatives thereof.

20. The lithium battery of claim 17, wherein the nonaqueous organic solvent is at least one mixture of nonaqueous organic solvents selected from the group consisting of ethylene carbonate, propylene carbonate, dimethyl carbonate, diethyl carbonate and dimethylethyl carbonate.

21. A lithium battery comprising:
a cathode;
an anode; and
a polymer electrolyte interposed between said cathode and said anode, said polymer electrolyte comprising:
a polymer matrix;
a lithium salt;
a nonaqueous organic solvent;
an ethylenically unsaturated compound; and
fluorobenzene,
wherein the ethylenically unsaturated compound has a boiling point at or between 50 and 170° C., a content thereof is at or between 0.01 to 6% by weight, based on a total weight of the nonaqueous organic solvent, and a content of the fluorobenzene is at or between 5 and 15% by weight, based on a total weight of the nonaqueous organic solvent.

22. The lithium battery of claim 21, wherein the content of the ethylenically unsaturated compound is at or between 1.5 to 2.5% by weight, based on the total weight of the nonaqueous organic solvent.

23. The lithium battery of claim 21, wherein the ethylenically unsaturated compound is at least one selected from the group consisting of vinylene carbonate, vinyl sulfone, acrylonitrile, and derivatives thereof.

24. The lithium battery of claim 21, wherein the nonaqueous organic solvent is at least one mixture of nonaqueous organic solvents selected from the group consisting of ethylene carbonate, propylene carbonate, dimethyl carbonate, diethyl carbonate and dimethylethyl carbonate.

25. A lithium battery comprising:
a cathode;
an anode; and
a gel type polymer electrolyte interposed between said cathode and said anode, said polymer electrolyte comprising a thermopolymerizable polymer or its monomer, a lithium salt, a nonaqueous organic solvent, and an ethylenically unsaturated compound,
wherein the ethylenically unsaturated compound has a boiling point at or between 50 and 170° C., and a content thereof is at or between 0.01 to 6% by weight, based on a total weight of the nonaqueous organic solvent.

26. The lithium battery of claim 25, wherein:
said gel type polymer electrolyte further comprises fluorobenzene, and
a content of the fluorobenzene is at or between 5 and 15% by weight, based on a total weight of the nonaqueous organic solvent.

27. The lithium battery of claim 25, wherein said gel-type polymer is formed by coating said gel-type polymer on the one of said anode and cathode, and thermopolymerizing the coating coated on one of said anode and said cathode.

28. The lithium battery of claim 25, wherein said gel-type polymer comprises a separator formed by forming a layer of said gel-type polymer, and thermopolymerizing the layer to form the separator.

29. The lithium battery of claim 25, wherein said anode further comprises a coating of the ethylenically unsaturated compound formed during a charging of the lithium battery.

30. The lithium battery of claim 29, wherein the organic solvent comprises a multi-component organic solvent.

31. The lithium battery of claim 30, wherein the ethylenically unsaturated compound is at least one selected from the group consisting of vinylene carbonate, vinyl sulfone, acrylonitrile, and derivatives thereof.

32. A method of preparing a lithium battery, comprising:
preparing a polymer electrolyte by combining a lithium salt, a nonaqueous organic solvent, and an ethylenically unsaturated compound with one of a polymeric matrix and a gel-type polymer comprising a thermopolymerizable polymer or its monomer; and
placing the prepared polymer electrolyte between a cathode and an anode,
wherein the ethylenically unsaturated compound has a boiling point at or between 50 and 170° C., and a content thereof is at or between 0.01 to 6% by weight, based on a total weight of the nonaqueous organic solvent.

33. The method of claim 32, wherein:
the polymer electrolyte comprises the polymeric matrix and the polymeric matrix comprises voids,
said preparing the polymer electrolyte further comprises impregnating an organic electrolytic solution of the lithium salt and the nonaqueous organic solvent into the voids, and
the method further comprises laminating a structure resulting from placing the prepared polymer electrolyte between the cathode and the anode.

34. The method of claim 32, wherein:
the polymer electrolyte comprises the gel-type polymer,
said preparing the polymer electrolyte further comprises adding a mixed solution of the lithium salt, the nonaqueous organic solvent, the ethylenically unsaturated compound, and the thermopolymerizable polymer or its monomer, and thermopolymerizing the mixed solution to prepare a separator,
said placing the prepared polymer electrolyte between the cathode and the anode comprises placing the separator between the cathode and the anode, and
the method further comprises winding the combined cathode, separator, and anode to form an electrode assembly and placing the electrode assembly into a pouch.

35. The method of claim 32, wherein:
the polymer electrolyte comprises the gel-type polymer,
said placing the prepared polymer electrolyte between the cathode and the anode comprises coating one of the anode and the cathode with a mixed solution of the lithium salt, the nonaqueous organic solvent, the ethylenically unsaturated compound, and the thermopolymerizable polymer or its monomer, and thermopolymerizing the coated one of the anode and the cathode,
combining the coated one of the anode and the cathode with other of the anode and the cathode such that the coating is between the anode and the cathode, and
the method further comprises winding the combined cathode and anode to form an electrode assembly and placing the electrode assembly into a pouch.

36. The method of claim 32, further comprising charging the lithium battery after said placing the prepared polymer electrolyte between the cathode and the anode to form a layer of the ethylenically unsaturated compound on the anode.

37. The method of claim 36, wherein the organic solvent comprises a multi-component organic solvent.

38. The method of claim 37, wherein the ethylenically unsaturated compound is at least one selected from the group consisting of vinylene carbonate, vinyl sulfone, acrylonitrile, and derivatives thereof.

39. The method of claim 32, wherein:
said preparing the polymer electrolyte further combines fluorobenzene to prepare the polymer electrolyte, and
a content of the fluorobenzene is at or between 5 and 15% by weight, based on a total weight of the nonaqueous organic solvent.

40. The method of claim 32, wherein:
said preparing the polymer electrolyte further combines propylene carbonate to prepare the polymer electrolyte, and
a content of the propylene carbonate is at or between 5 and 15% by weight, based on a total weight of the nonaqueous organic solvent.
